(19) United States
(12) Patent Application Publication
(10) Pub. No.: US 2026/0330544 A1
(43) Pub. Date: Oct. 22, 2026

(54) SYSTEMS AND METHODS FOR PROVIDING USER INTERFACES TO FACILITATE ACCOUNT MIGRATION, ACCOUNT OPENING, AND ACCOUNT UPDATES

(71) Applicants: Jessica Ann Seiwert, Corona, CA (US); Mark William Thatcher, Bermuda Dunes, CA (US)

(72) Inventors: Jessica Ann Seiwert, Corona, CA (US); Mark William Thatcher, Bermuda Dunes, CA (US)

(21) Appl. No.: 19/180,447

(22) Filed: Apr. 16, 2025

(51) Int. Cl. G06Q 40/02; G06F 16/334

(52) U.S. Cl. CPC G06Q 40/022; G06F 16/334

(57) ABSTRACT

Systems and methods for providing user interfaces to facilitate account migration, opening, and updating for account holders for accounts with services are disclosed. Exemplary implementations may: present a client user interface to an account holder; present an administrative user interface to an administrative user; select fillable forms based on user input; transfer fillable forms to a signature service provider; present a personalized link to the account holder; receive a set of signed forms; notify the account holder to confirm migration of a first account of the account holder from a first services provider to a second services provider, and/or perform other steps.

### FIELD OF THE DISCLOSURE

The present disclosure relates to systems and methods for providing user interfaces to facilitate account migration, account opening, and account updates for account holders of services providers, particularly financial services providers.

### BACKGROUND

Providers of services, including but not limited to financial services providers such as banks, credit unions, brokerage firms, insurance companies, tax and accounting firms, real estate companies, credit card companies, and other service providers are known. Professional services, such as tax services, legal services, information technology (IT) services, marketing services, healthcare services, medical services, dental services, educational services, training services, public relations (PR) services, creative services, staffing services, financial services, and other professional services are known. The concept of accounts and account holders is known. The concept of opening new accounts is known. The concept of updating existing accounts is known. The concept of migrating accounts between providers of services is known. Machine learning models, including large language models, are known.

### SUMMARY

One aspect of the present disclosure relates to a (computer) system configured to provide user interfaces to facilitate migrating accounts of account holders between services providers. As used herein, the phrase “configured to” is intended to be interpreted broadly, as “being capable of or suitable for performing” some function or feature, without requiring any adaptations to provide said function or feature. The system may include electronic storage, one or more hardware processors, and/or other components. The system may be configured to store electronic information. The electronic information may include fillable forms. The system may be configured to present a client user interface to an account holder. The system may be configured to present an administrative user interface to an administrative user. The system may be configured to select fillable forms based on user input. The system may be configured to transfer fillable forms to a signature service provider. The system may be configured to present a personalized link to the account holder; receive a set of signed forms. The system may be configured to notify the account holder to confirm migration of a first account of the account holder from a first services provider to a second services provider. Any of these steps performed by the system may be performed automatically. The system may be configured to perform other steps.

Another aspect of the present disclosure relates to a (computer) system configured to provide user interfaces to facilitate account opening of new accounts and/or account updates of existing accounts of account holders.

Another aspect of the present disclosure relates to a method of providing user interfaces to facilitate migrating accounts of account holders between services providers. The method may include presenting a client user interface to an account holder. The method may include presenting an administrative user interface to an administrative user. The method may include selecting fillable forms based on user input. The method may include transferring fillable forms to a signature service provider. The method may include presenting a personalized link to the account holder. The method may include receiving a set of signed forms. The method may include notifying the account holder to confirm migration of a first account of the account holder from a first services provider to a second services provider. Any of these steps may be performed automatically. The method may include performing other steps.

Another aspect of the present disclosure relates to a method of providing user interfaces to facilitate account opening of new accounts and/or account updates of existing accounts of account holders.

As used herein, any association (or relation, or reflection, or indication, or correspondency) involving servers, processors, client computing platforms, user interfaces, presentations, characteristics, descriptions, forms, events, neural networks, machine learning models, databases, formats, instructions, operations, determinations, notifications, and/or another entity or object that interacts with any part of the system and/or plays a part in the operation of the system, may be a one-to-one association, a one-to-many association, a many-to-one association, and/or a many-to-many association or “N”-to-“M” association (note that “N” and “M” may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to provide user interfaces to facilitate account migration, opening, and updating for account holders for accounts with services providers, in accordance with one or more implementations.

FIG. 2 illustrates a method of providing user interfaces to facilitate account migration, opening, and updating for account holders for accounts with services providers, in accordance with one or more implementations.

FIG. 3A illustrates an exemplary client user interface, as may be used by a system configured to provide user interfaces to facilitate account migration, opening, and updating for account holders for accounts with services providers, in accordance with one or more implementations.

FIG. 3B illustrates an exemplary administrative user interface, as may be used by a system configured to provide user interfaces to facilitate account migration, opening, and updating for account holders for accounts with services providers, in accordance with one or more implementations.

FIG. 4 illustrates a neural network, as may be used by a system configured to provide user interfaces to facilitate account migration, opening, and updating for account holders for accounts with services providers, in accordance with one or more implementations.

### DETAILED DESCRIPTION

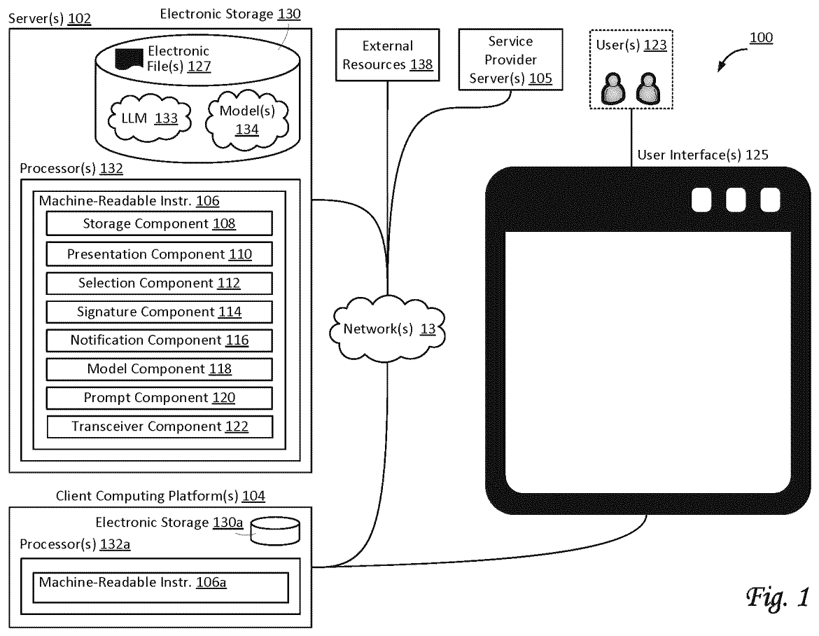

FIG. 1 illustrates a system 100 configured to provide user interfaces to facilitate account migration, opening, and updating for account holders for accounts with services providers, in accordance with one or more implementations. In some implementations, system 100 may include one or more servers 102, one or more client computing platforms 104, one or more service provider servers 105, one or more external resources 138, one or more user interfaces 125, one or more machine learning models 134, a large language model (LLM) 133, and/or other components. Users 123 may include one or more of a first user, a second user, an administrative user, and/or other users. Server(s) 102 may be configured to communicate with one or more client computing platforms 104 according to a client/server architecture, a peer-to-peer architecture, and/or other architectures. Client computing platform(s) 104 may be configured to communicate with other remote platforms via server(s) 102 and/or according to a client/server architecture, a peer-to-peer architecture, and/or other architectures. Users may access system 100 via client computing platform(s) 104. In some implementations, system 100 and/or server(s) 102 may be configured to communicate with one or more of service provider servers 105, users 123, and/or other components. In some implementations, machine learning models 134 may include large language model 133.

The service(s) providers may include financial services providers such as banks, credit unions, brokerage firms, insurance companies, tax and accounting firms, real estate companies, credit card companies, and other service providers. In some cases, the service(s) providers may provide one or more professional services, such as tax services, legal services, IT services, marketing services, healthcare services, medical services, dental services, educational services, training services, PR services, creative services, staffing services, financial services, and other professional services. The service(s) providers may include a first services provider, a second services provider, etc.

Account holders may own, hold, manage, control, and/or otherwise use accounts at one or more services providers. An account holder may include one or more of an individual person, a group of people, an organization, a member of the organization, customers of the organization, and/or another entity. Users 123 may be account holders, and/or otherwise own, hold, manage, control, and/or otherwise use accounts at one or more services providers. For example, an individual user or account holder may manage an individual user account at an individual services provider. That user account is associated with or related to that account holder, and vice versa.

Server(s) 102 may be configured by machine-readable instructions 106. Machine-readable instructions 106 may include one or more instruction components. The instruction components may include computer program components. The instruction components may include one or more of a storage component 108, a presentation component 110, a selection component 112, a signature component 114, a notification component 116, a model component 118, a prompt component 120, a transceiver component 122, and/or other instruction components.

Storage component 108 may be configured to store electronic information, e.g., in electronic storage 130. The electronic information may include electronic files 127, such as, e.g., fillable forms. A first set of fillable forms may be associated with a first services provider, a second set of fillable forms may be associated with a second services provider, and so forth. By way of non-limiting example, a common format for fillable forms is Portable Document Format, or PDF. In some implementations, storage component 108 may be configured to retrieve information from electronic storage 130.

Presentation component 110 may be configured to effectuate presentations of information to users 123, including account holders and/or other users. The presented information may include user interfaces 125, such as, e.g., a client user interface, an administrative user interface, and/or other user interfaces. For example, presentation component 110 may present a client user interface to an account holder, on client computing platform 104. The client user interface is configured to obtain client user input from the account holder. As another example, presentation component 110 may present an administrative user interface to an administrative user, on another client computing platform 104. The administrative user interface is configured to obtain administrative user input from the administrative user.

For example, assume a particular account holder wants to migrate an account from a particular or current services provider to a different or new services provider. A client user interface may be configured to obtain client user input from the particular account holder to provide a set of account information items pertaining to the particular account of the particular account holder with the current services provider. For example, the current services provider may be a bank or other financial services provider. The set of account information items may include a first bank account (identified by a first bank account number) of a first bank account type (e.g., savings account, checking account, money market account, certificates of deposit account, Roth IRA account, Roth 401(k) account, etc. etc.). The set of account information items may include a second bank account (identified by a second bank account number) of a second bank account type, and so forth. In some implementations, a set of account information items may be provided as one or more of a PDF file, a photograph, a scan, a Portable Network Graphics (PNG) file, a Tagged Image File Format (TIF or TIFF) file, a Joint Photographic Experts Group (JPG or JPEG) file, an email, a comma separated values (CSV) file, an electronic file, and/or in another (electronic) format, preferably containing human-readable information. For example, the particular account holder may upload, capture, and/or otherwise provide, through the client user interface, a list or table with account information regarding the first bank account and the second bank account, including current balances.

In some implementations, a client user interface may be configured to obtain client user input from the particular account holder to provide signature information. For example, signature information may represent a signature of the particular account holder, and/or of a person authorized to provide signatures regarding a particular account. In some cases, signature information depicts a signature of the particular account holder. In other cases, signature information includes an electronic signature of the particular account holder. In some cases, signature information includes a digital signature of the particular account holder, implying cryptographic proof of the authenticity and integrity of one or more documents and the particular account holder's signature. In some implementations, a client user interface may be configured to obtain client user input from the particular account holder to upload information, including but not limited to (supporting) documents, personal information, and/or other information. For example, the particular account holder may upload a voided check from a bank account at the current financial services provider. For example, the particular account holder may upload a utility bill to help establish a residence address. For example, the particular account holder may upload and/or otherwise provide a social security number, a date of birth, a marriage certificate, and/or other personal information.

For example, assume a particular account holder wants to open or update a new or existing account with a particular services provider. A client user interface may be configured to obtain client user input from the particular account holder to provide a set of account information items pertaining to the new or updated account.

An administrative user interface may be configured to obtain administrative user input from an administrative user to provide and/or otherwise add one or more fillable forms, e.g., for a particular services provider. New forms may be tagged for their particular purpose, e.g., by a description in the metadata of a form. In some cases, the administrative user may replace and/or modify one or more fillable forms in electronic storage 130. In some implementations, the administrative user may provide personal information of a particular account holder, e.g., to fill or prefill fillable forms for the particular account holder. In some implementations, an administrative user interface may be configured to obtain administrative user input from the administrative user to select (and/or confirm selection of) certain fillable forms, e.g., from a set of fillable forms. In some implementations, an administrative user interface may be configured to obtain administrative user input from the administrative user to initiate and/or confirm operations of system 100, such as migrating accounts of a particular account holder between two particular services providers, or opening a new account, or updating an existing account. Administrative tasks performed through an administrative user interface may be referred to as the backend of system 100, or as “backend tasks”.

Selection component 112 may be configured to select fillable forms, e.g., from electronic storage 130. In particular, selection component 112 may select a subset of the set of available fillable forms. Selection by selection component 112 may be based on the set of account information as provided by a particular account holder through a client user interface. For example, a first subset of fillable forms may be selected based on the account information items pertaining to the particular account of the particular account holder with the current services provider. For example, a second subset of fillable forms may be selected based on the new services provider, as well as the provided set of account information items.

Assume the provided set of account information items include a first and second bank account with a current bank. To migrate these accounts to a new bank, one or more fillable forms (i.e., the first subset) may be selected that are specific to the current bank. Additionally, one or more fillable forms (i.e., the second subset) may be selected that are specific to the new bank. In some implementations, selections by selection component 112 may be based, at least in part, on replies and/or other output from a machine learning model, such as, by way of non-limiting example, large language model 133. In some implementations, at least some selections by selection component 112 may be based, at least in part, on administrative user input from the administrative user. In some implementations, a selected set of fillable forms and/or other information may be presented to an administrative user, e.g., in an administrative user interface, for review by the administrative user (who can add, delete, modify, and/or confirm selected forms). In some implementations, a selected set of fillable forms and/or other information may be grouped together in a container, envelope, zip-file, and/or other mechanism for organizing electronic files, for convenient transfer, e.g., to a signature service provider.

Signature component 114 may be configured to send and/or receive information to and/or from a signature service provider. In some implementations, signature component 114 may receive a link (e.g., a Uniform Resource Locator or URL) that is specific to a particular account holder. For example, a received link may be personalized for the particular account holder. In some implementations, signature component 114 may electronically transfer a (subset of a) set of fillable forms to signature service provider. For example, the subset of fillable forms may have been selected using selection component 112. In some implementations, signature component 114 may receive a set of signed forms that have been signed by an account holder. For example, the set of signed forms may include signature information that has been provided by the account holder. In some cases, a signature service provider may be DOCUSIGN™, DROPBOX™, SIGNNOW™, ADOBE ACROBAT SIGN™ SHAREFILE™, PANDADOC™, or another signature service provider. In some implementations, signature component 114 may be configured to receive and/or otherwise obtain signatures and/or signature information from account holders, e.g., through a client user interface.

Notification component 116 may be configured to generate and/or transmit notifications, e.g., to account holders and/or other users. For example, a particular notification may confirm initiation, progress, and/or completion of the migration of one or more particular accounts between services providers. For example, a particular notification may confirm opening of a new account or updating of an existing account with a particular services provider. In some cases, a notification may be sent via mail. In some cases, notifications may be sent electronically. In some cases, a notification may be presented to an account holder via a user interface, e.g., through presentation component 110.

Model component 118 may be configured to obtain, access, use, and/or fine-tune one or more machine learning models, including one or more of machine learning models 134 and/or large language model (LLM) 133. In some implementations, large language model 133 may have been trained on at least a million documents. In some implementations, large language model 133 may have been trained on at least 100 million documents. In some implementations, large language model 133 may include and/or be based on a neural network using over a billion parameters and/or weights. In some implementations, large language model 133 may include and/or be based on a neural network using over a 100 billion parameters and/or weights. In some implementations, model component 118 may provide prompts and/or prompt information (e.g., as generated using prompt component 120) to one or more machine learning models, including one or more of machine learning models 134 and/or large language model (LLM) 133.

In some implementations, large language model 133 may be based on Generative Pre-trained Transformer 3 (GPT3). In some implementations, large language model 133 may be based on ChatGPT, as developed by OpenAI™. In some implementations, large language model 133 may be derived from Generative Pre-trained Transformer 3 (GPT3) or a successor of Generative Pre-trained Transformer 3 (GPT3). In some implementations, model component 112 may be configured to fine-tune large language model 133 through a set of documents (e.g., training documents). In some cases, the training documents may include forms, account information, financial documents, including but not limited to bank statements, insurance documents, mortgage documents, loan documents, and/or other documents. Large language model 133 may be able to determine and/or use whether information is formatted in a column, or a row, or a table. Accordingly, information elements in a column, or a row, or a table may be contextually and/or semantically linked and/or otherwise connected such that large language model 133 may extract information from a particular document based on knowledge of the formatted information in the particular document. In some implementations, model component 118 may be configured to obtain and/or present replies to queries from large language model 133. In some implementations, system 100 may be configured to interact with machine learning models 134 and/or LLM 133, e.g., through Application Programming Interface (API) calls (e.g., as provided by OPENAI™ or other publicly available Artificial Intelligence (AI) service providers).

Prompt component 120 may be configured to generate prompts, prompt information, and/or descriptions, e.g., for one or more machine learning models 134, large language model (LLM) 133, and/or other models. For example, prompt component 120 may generate prompt information defining a prompt for one or more machine learning models 134 that is based on a set of account information (e.g., as provided by a particular account holder through a client user interface). Prompt component 120 may be configured to provide prompts and/or prompt information to one or more machine learning models 134, large language model (LLM) 133, and/or other models, which may be configured to generate a particular reply to a particular prompt. For example, a particular reply may include a set of account numbers and corresponding account types that have been extracted from a particular set of account information. In some implementations, selections by selection component 112 may be based on replies by, e.g., large language model 133.

In some implementations, prompt component 120 may generate prompt information defining a prompt for one or more machine learning models 134 to select a subset of fillable forms based on a set of account information (e.g., as provided by a particular account holder through a client user interface). In some implementations, selection component 112 may obtain a set or subset of fillable forms from one or more replies by large language model 133.

Transceiver component 122 may be configured to transmit, transfer, and/or receive information. In some implementations, transceiver component 122 may transfer information to one or more machine learning models 134, large language model (LLM) 133, and/or other models, including but not limited to context information and prompts. In some implementations, transceiver component 122 may receive information from one or more machine learning models 134, large language model (LLM) 133, and/or other models, including but not limited to replies. In some implementations, transceiver component 122 may transfer information to one or more service provider servers 105, such as a signature service provider, such as, by way of non-limiting example, a set of fillable forms. In some implementations, transceiver component 122 may transfer information from one or more service provider servers 105 to system 100, such as a personalized link received from a signature service provider, and/or a set of signed forms that have been signed by a particular account holder. In some cases, information, such as a personalized link, may be transferred via a text message or email. In other cases, information such as a personalized link may be presented to a particular account holder in a particular client user interface.

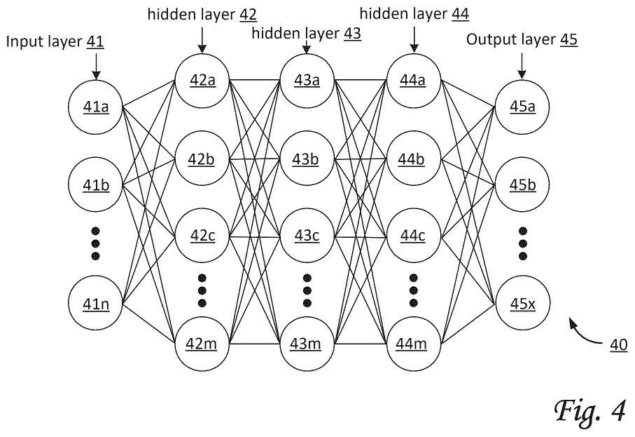

By way of non-limiting example, FIG. 4 illustrates a neural network 40, including an input layer 41 of nodes, hidden layers 42, 43, and 44, and output layer 45. For example, input nodes 41a, 41b, . . . , 41n may represent “n” inputs to neural network 40. Each input may represent part of a textual description. The depiction of three hidden layers is merely exemplary, and another numbers of hidden layers are considered within the scope of this disclosure. Hidden nodes 42a, 42b, . . . , 42m may represent “m” nodes connected to input layer 41. Hidden nodes 43a, 43b, . . . , 43m may represent “m” nodes connected to hidden layer 42. Hidden nodes 44a, 44b, . . . , 44m may represent “m” nodes connected to hidden layer 43. The number “m” may be different for different hidden layers, and typically gets smaller towards output layer 45, where output nodes 45a, 45b, . . . , 45x may represent “x” output nodes, connected to hidden layer 44. Typically, the number “x” is much smaller than “n” or “m”. Output layer 45 may represent a multidimensional vector of a particular dimensionality (here, a dimensionality of “x”). Here, neural network 40 is depicted as fully connected, but that is merely an example, and not intended to be limiting. In some implementations, output layer 45 may represent a set of account types (e.g., based on input representing a set of account information). In some implementations, a neural network similar to or the same as neural network 40 may be specific to and/or trained for) a particular type of classification or extraction of information from a set of account information. In some implementations, a neural network similar to or the same as neural network 40 may be specific to and/or trained for terms and/or phrases pertaining to accounts, and account information).

In some implementations, system 100 and/or model component 118 may be configured to train and/or fine-tune a pre-trained text-based system to generate a multi-dimensional vector that represents account information. In some implementations, an additional (artificial) neural network (e.g., similar to neural network 40 in FIG. 4) may be trained and used to convert and/or transform a multi-dimensional vector into information that represents a selection of fillable forms. In some implementations, an additional neural network (e.g., similar to neural network 40 in FIG. 4) may be trained and used to take a multi-dimensional vector as input and classify the information or extract information from this input. In some implementations, other types of machine-learning techniques may be used instead of or in addition to the additional neural network discussed in this paragraph.

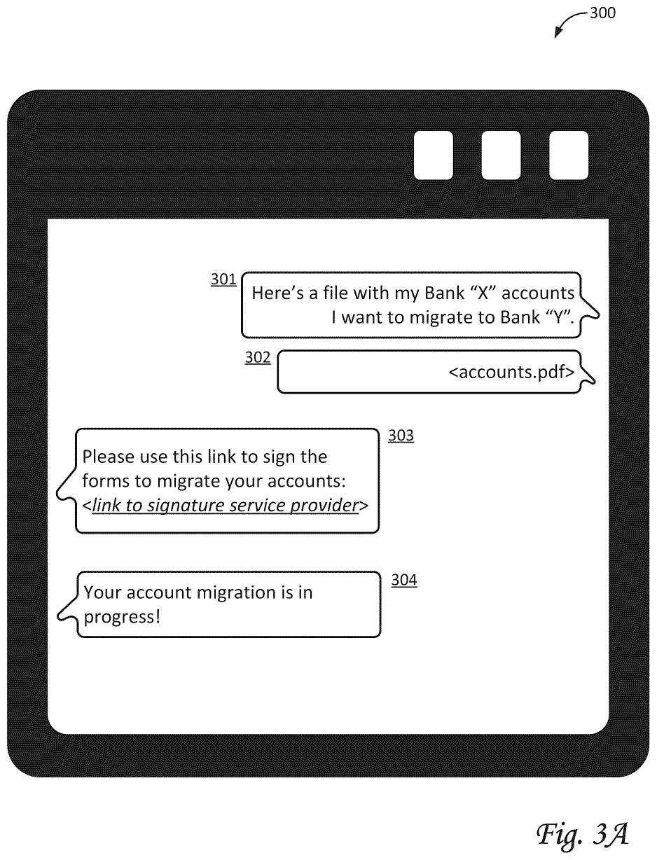

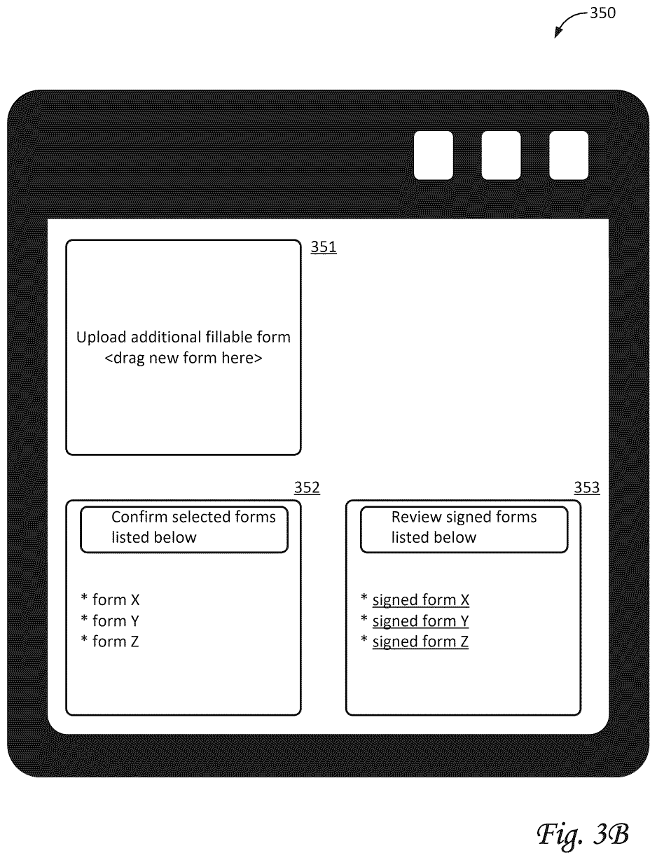

FIG. 3A illustrates an exemplary user interface 300 depicting a client user interface as may be used by a system configured to provide user interfaces to facilitate account migration, opening, and updating for account holders for accounts with services providers, in accordance with one or more implementations. User interface element 301 represents client user input provided by a particular account holder, e.g., regarding the migration of certain accounts. Similarly, other client user input could indicate a request for opening a new account or updating an existing account. User interface element 302 represents client user input, specifically a set of account information, as provided by the particular account holder. User interface element 303 represents information provided to the particular account holder, e.g., through an administrative user, that includes a personalized link that the particular account holder can use to access information (and provide signature information) at a signature provider service. User interface element 304 represents a notification from the system to the particular account holder, and may correspond to the particular client user input, e.g., in user interface element 301.

FIG. 3B illustrates an exemplary user interface 350 depicting an administrative user interface as may be used by a system configured to provide user interfaces to facilitate account migration, opening, and updating for account holders for accounts with services providers, in accordance with one or more implementations.

User interface element 351 represents administrative user input provided by a particular administrative user, regarding additional fillable forms to be used for, e.g., the migration of certain accounts. User interface element 352 represents administrative user input, specifically for the particular administrative user to confirm (or modify) a set of selected forms. User interface element 353 represents information provided to the particular administrative user, that includes links to or copies of signed forms that have been signed by an account holder.

Referring to FIG. 1, in some implementations, server(s) 102, client computing platform(s) 104, and/or external resources 138 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 138 may be operatively linked via some other communication media.

A given client computing platform 104 may include one or more processors configured to execute computer program components. The computer program components may be configured to enable an expert or user associated with the given client computing platform 104 to interface with system 100 and/or external resources 138, and/or provide other functionality attributed herein to client computing platform(s) 104. By way of non-limiting example, a given client computing platform 104 and/or a given server 102 may include one or more of a server, a desktop computer, a laptop computer, a handheld computer, a tablet computing platform, a NetBook, a Smartphone, a gaming console, and/or other computing platforms. In some implementations, client computing platforms 104 may include electronic storage 130a that is the same as or similar to electronic storage 130. In some implementations, client computing platforms 104 may include processor(s) 132a that are the same as or similar to processor(s) 132. In some implementations, client computing platforms 104 may include machine-readable instructions 106a that are the same as or similar to machine-readable instructions 106.

User interface(s) 125 may be configured to facilitate interaction between users 123 and system 100 and/or between users 123 and client computing platforms 104. For example, user interfaces 125 may provide an interface through which users 123 may provide information to and/or receive information from system 100, and/or vice versa. In some implementations, user interface 125 may include one or more of a display screen, touchscreen, monitor, a keyboard, buttons, switches, knobs, levers, mouse, microphones, sensors to capture voice commands, sensors to capture body movement, sensors to capture hand and/or finger gestures, and/or other user interface devices configured to receive and/or convey user input. In some implementations, one or more user interfaces 125 may be included in one or more client computing platforms 104. In some implementations, one or more user interfaces 125 may be included in system 100. In some implementations, user interface 125 may depict and/or otherwise include one or more frames, borders, page sections, buttons, and/or other user interface elements.

External resources 138 may include sources of information outside of system 100, external entities participating with system 100, and/or other resources. For example, in some cases, external resources 138 may include a machine learning model. For example, in some cases, external resources 138 may include a signature service provider. In some implementations, some or all of the functionality attributed herein to external resources 138 may be provided by resources included in system 100.

Server(s) 102 may include electronic storage 130, one or more processors 132, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 130 may comprise non-transitory storage media that electronically stores information. The electronic storage media of electronic storage 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from server(s) 102, information received from client computing platform(s) 104, and/or other information that enables server(s) 102 to function as described herein.

Processor(s) 132 may be configured to provide information processing capabilities in server(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination. Processor(s) 132 may be configured to execute components 108, 110, 112, 114, 116, 118, 120, 122, and/or other components. Processor(s) 132 may be configured to execute components 108, 110, 112, 114, 116, 118, 120, 122, and/or other components by software; hardware; firmware; some combination of software, hardware, and/or firmware; and/or other mechanisms for configuring processing capabilities on processor(s) 132. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, and/or 122 are illustrated in FIG. 1 as being implemented within a single processing unit, in implementations in which processor(s) 132 includes multiple processing units, one or more of components 108, 110, 112, 114, 116, 118, 120, and/or 122 may be implemented remotely from the other components. The description of the functionality provided by the different components 108, 110, 112, 114, 116, 118, 120, and/or 122 described below is for illustrative purposes and is not intended to be limiting, as any of components 108, 110, 112, 114, 116, 118, 120, and/or 122 may provide more or less functionality than is described. For example, one or more of components 108, 110, 112, 114, 116, 118, 120, and/or 122 may be eliminated, and some or all of its functionality may be provided by other ones of components 108, 110, 112, 114, 116, 118, 120, and/or 122. As another example, processor(s) 132 may be configured to execute one or more additional components that may perform some or all of the functionality attributed below to one of components 108, 110, 112, 114, 116, 118, 120, and/or 122.

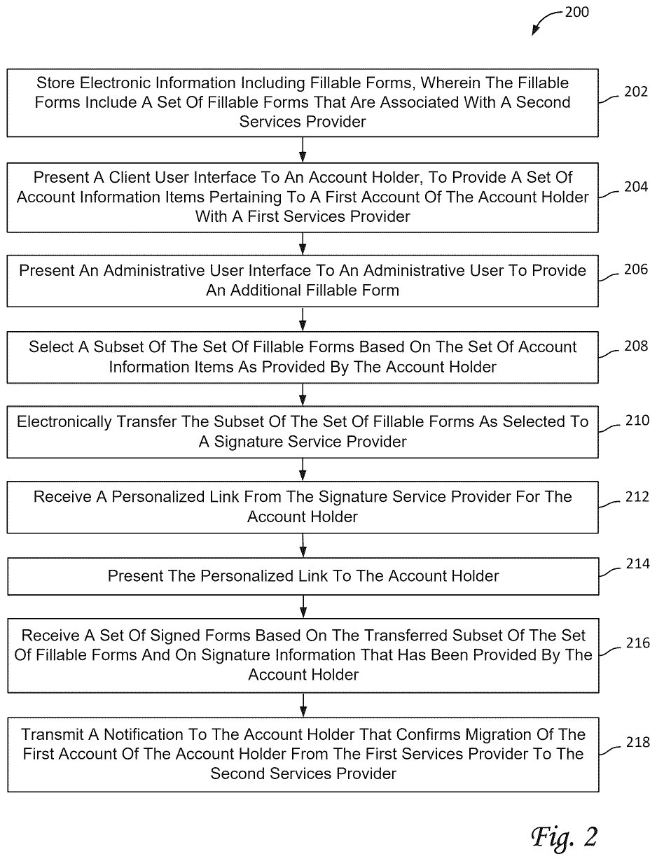

FIG. 2 illustrates method 200 of providing user interfaces to facilitate account migration, opening, and updating for account holders for accounts with services providers, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting. In some implementations, the operations of method 200 are performed automatically, using specialized hardware components configured to perform the operations.

At an operation 202, electronic information is stored. The electronic information includes fillable forms. The fillable forms include a set of fillable forms that are associated with the second services provider. In some embodiments, operation 202 is performed by a storage component the same as or similar to storage component 208 (shown in FIG. 1 and described herein).

At an operation 204, a presentation of a client user interface is effectuated to an account holder. The client user interface obtains client user input from the account holder to provide a set of account information items pertaining to a first account of the account holder with the first services provider. In some embodiments, operation 204 is performed by a presentation component the same as or similar to presentation component 110 (shown in FIG. 1 and described herein).

At an operation 206, a presentation of an administrative user interface is effectuated to an administrative user. The administrative user interface obtains administrative user input from the administrative user to provide an additional fillable form for storage in the electronic storage, and to associate a particular fillable form with a particular services provider. In some embodiments, operation 206 is performed by a presentation component the same as or similar to presentation component 110 (shown in FIG. 1 and described herein).

At an operation 208, a subset of the set of fillable forms is selected. The selection is based on the set of account information items as provided by the account holder. In some embodiments, operation 208 is performed by a selection component the same as or similar to selection component 112 (shown in FIG. 1 and described herein).

At an operation 210, the subset of the set of fillable forms as selected is electronically transferred to a signature service provider. In some embodiments, operation 210 is performed by a signature component the same as or similar to signature component 114 (shown in FIG. 1 and described herein).

At an operation 212, a personalized link is received from the signature service provider for the account holder. In some embodiments, operation 212 is performed by a signature component the same as or similar to signature component 114 (shown in FIG. 1 and described herein).

At an operation 214, the personalized link is presented to the account holder. In some embodiments, operation 214 is performed by a presentation component the same as or similar to presentation component 110 (shown in FIG. 1 and described herein).

At an operation 216, a set of signed forms that have been signed by the account holder is received. The set of signed forms is based on the transferred subset of the set of fillable forms and on signature information that has been provided by the account holder. In some embodiments, operation 216 is performed by a signature component and/or a transceiver component the same as or similar to signature component 114 and/or transceiver component 122 (shown in FIG. 1 and described herein).

At an operation 218, a notification is transmitted to the account holder. The notification confirms migration of the first account of the account holder from the first services provider to the second services provider. In some embodiments, operation 218 is performed by a notification component the same as or similar to notification component 116 (shown in FIG. 1 and described herein).

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to provide user interfaces to facilitate migrating accounts of account holders between services providers, wherein the service providers include a first services provider and a second services provider, the system comprising:
electronic storage configured to store electronic information, wherein the electronic information includes fillable forms, wherein the fillable forms include a set of fillable forms that are associated with the second services provider; and
one or more hardware processors configured by machine-readable instructions to:
effectuate a presentation of a client user interface to an account holder, wherein the client user interface is configured to obtain client user input from the account holder to provide a set of account information items pertaining to a first account of the account holder with the first services provider;
effectuate a presentation of an administrative user interface to an administrative user, wherein the administrative user interface is configured to obtain administrative user input from the administrative user to:
(i) provide an additional fillable form for storage in the electronic storage;
(ii) associate a particular fillable form with a particular services provider;
select a subset of the set of fillable forms, wherein the selection is based on the set of account information items as provided by the account holder;
electronically transfer the subset of the set of fillable forms as selected to a signature service provider;
receive a personalized link from the signature service provider for the account holder;
present the personalized link to the account holder;
receive a set of signed forms that have been signed by the account holder, wherein the set of signed forms is based on the transferred subset of the set of fillable forms and on signature information that has been provided by the account holder; and
transmit a notification to the account holder, wherein the notification confirms migration of the first account of the account holder from the first services provider to the second services provider.

2. The system of claim 1, wherein the one or more hardware processors are further configured to:
generate prompt information defining a prompt for a machine learning model, wherein the prompt is based on the set of account information;
provide the prompt as input to the machine learning model, wherein the machine learning model is configured to generate a reply to the prompt, wherein the reply includes a set of account numbers and corresponding account types that have been extracted from the set of account information; and
obtain, from the machine learning model, the reply to the prompt such that the set of account numbers and the corresponding account types is obtained,
wherein the selection of the subset of fillable forms is based on the reply.

3. The system of claim 1, wherein the one or more hardware processors are further configured to:
generate prompt information defining a prompt for a machine learning model, wherein the prompt is based on the set of account information;
provide the prompt as input to the machine learning model, wherein the machine learning model is configured to generate a reply to the prompt, wherein the reply indicates the subset of the set of fillable forms that have been selected by the machine learning model; and
obtain, from the machine learning model, the reply to the prompt such that the subset of the set of fillable forms is obtained.

4. The system of claim 1, wherein the one or more hardware processors are further configured to:
prefill information in the subset of the set of fillable forms, wherein the prefilled information pertains to one or both of the account holder and/or the second services provider.

5. The system of claim 1, wherein the one or more hardware processors are further configured to:
generate a container that includes the subset of the set of fillable forms as selected, wherein the container is transferred electronically to the signature service provider.

6. The system of claim 1, wherein the client user interface is further configured to obtain the client user input from the account holder to:
upload one or more supporting documents that support the migration of the first account of the account holder from the first services provider to the second services provider.

7. The system of claim 1, wherein the client user interface is further configured to obtain the client user input from the account holder to:
provide personal information that is personal to the account holder, wherein the personal information is needed to fill in the subset of the set of fillable forms.

8. The system of claim 1, wherein the administrative user interface is further configured to obtain the administrative user input from the administrative user to:
provide personal information that is personal to the account holder, wherein the personal information is needed to fill in the subset of the set of fillable forms.

9. The system of claim 1, wherein the administrative user interface is further configured to:
present the subset of the set of fillable forms as selected to the administrative user; and
receive additional administrative user input from the administrative user to confirm some or all of the fillable forms as selected for electronic transfer to the signature provider.

10. The system of claim 1, wherein the first services provider is a first bank, wherein the second services provider is a second bank, wherein the set of account information items includes at least a first bank account having a first bank account type and a second bank account having a second bank account type, wherein the first bank account type is different from the second bank account type.

11. A method of providing user interfaces to facilitate migrating accounts of account holders between services providers, wherein the service providers include a first services provider and a second services provider, the method comprising:
storing electronic information, wherein the electronic information includes fillable forms, wherein the fillable forms include a set of fillable forms that are associated with the second services provider;
effectuating a presentation of a client user interface to an account holder, wherein the client user interface obtains client user input from the account holder to provide a set of account information items pertaining to a first account of the account holder with the first services provider;
effectuating a presentation of an administrative user interface to an administrative user, wherein the administrative user interface obtains administrative user input from the administrative user to provide an additional fillable form for storage in the electronic storage, and to associate a particular fillable form with a particular services provider;
selecting a subset of the set of fillable forms, wherein the selection is based on the set of account information items as provided by the account holder;
electronically transferring the subset of the set of fillable forms as selected to a signature service provider;
receiving a personalized link from the signature service provider for the account holder;
presenting the personalized link to the account holder;
receiving a set of signed forms that have been signed by the account holder, wherein the set of signed forms is based on the transferred subset of the set of fillable forms and on signature information that has been provided by the account holder; and
transmitting a notification to the account holder, wherein the notification confirms migration of the first account of the account holder from the first services provider to the second services provider.

12. The method of claim 11, further comprising:
generating prompt information defining a prompt for a machine learning model, wherein the prompt is based on the set of account information;
providing the prompt as input to the machine learning model, wherein the machine learning model generates a reply to the prompt, wherein the reply includes a set of account numbers and corresponding account types that have been extracted from the set of account information; and
obtaining, from the machine learning model, the reply to the prompt such that the set of account numbers and the corresponding account types is obtained,
wherein the selection of the subset of fillable forms is based on the reply.

13. The method of claim 11, further comprising:
generating prompt information defining a prompt for a machine learning model, wherein the prompt is based on the set of account information;
providing the prompt as input to the machine learning model, wherein the machine learning model generates a reply to the prompt, wherein the reply indicates the subset of the set of fillable forms that have been selected by the machine learning model; and
obtain, from the machine learning model, the reply to the prompt such that the subset of the set of fillable forms is obtained.

14. The method of claim 11, further comprising:
prefill information in the subset of the set of fillable forms, wherein the prefilled information pertains to one or both of the account holder and/or the second services provider.

15. The method of claim 11, further comprising:
generating a container that includes the subset of the set of fillable forms as selected, wherein the container is transferred electronically to the signature service provider.

16. The method of claim 11, wherein the client user interface further obtains the client user input from the account holder to upload one or more supporting documents that support the migration of the first account of the account holder from the first services provider to the second services provider.

17. The method of claim 11, wherein the administrative user interface further obtains the administrative user input from the administrative user to provide personal information that is personal to the account holder, wherein the personal information is needed to fill in the subset of the set of fillable forms.

18. The method of claim 11, wherein the administrative user interface further:
(a) presents the subset of the set of fillable forms as selected to the administrative user; and
(b) receives additional administrative user input from the administrative user to confirm some or all of the fillable forms as selected for electronic transfer to the signature provider.

19. The method of claim 11, wherein the first services provider is a first bank, wherein the second services provider is a second bank, wherein the set of account information items includes at least a first bank account having a first bank account type and a second bank account having a second bank account type, wherein the first bank account type is different from the second bank account type.

20. A system configured to provide user interfaces to facilitate opening accounts for account holders with a particular services provider, the system comprising:
electronic storage configured to store electronic information, wherein the electronic information includes fillable forms, wherein the fillable forms include a set of fillable forms that are associated with the particular services provider; and
one or more hardware processors configured by machine-readable instructions to:
effectuate a presentation of a client user interface to an account holder, wherein the client user interface is configured to obtain client user input from the account holder to provide a set of account information items pertaining to a first account of the account holder to be opened with the particular services provider;
effectuate a presentation of an administrative user interface to an administrative user, wherein the administrative user interface is configured to obtain administrative user input from the administrative user to:
(i) provide an additional fillable form for storage in the electronic storage;
(ii) associate a particular fillable form with the particular services provider;
select a subset of the set of fillable forms, wherein the selection is based on the set of account information items as provided by the account holder;
electronically transfer the subset of the set of fillable forms as selected to a signature service provider;
receive a personalized link from the signature service provider for the account holder;
present the personalized link to the account holder;
receive a set of signed forms that have been signed by the account holder, wherein the set of signed forms is based on the transferred subset of the set of fillable forms and on signature information that has been provided by the account holder; and
transmit a notification to the account holder, wherein the notification confirms opening of the first account of the account holder with the particular services provider.
